(19) United States
(12) Patent Application Publication
(10) Pub. No.: US 2025/0245920 A1
(43) Pub. Date: Jul. 31, 2025

(54) TRAINING SYSTEM AND METHOD FOR SYNCHRONIZING VIRTUAL REALITY SITE STATE AND REAL-WORLD SITE STATE AND PERFORMING TRACKING OPTIMIZATION BASED ON DYNAMIC OBJECT IMPORTANCE

(71) Applicant: ELECTRONICS AND TELECOMMUNICATIONS RESEARCH INSTITUTE, Daejeon (KR)

(72) Inventors: Vladimirov Blagovest IORDANOV, Daejeon (KR); Sang Joon PARK, Daejeon (KR); SoYeon LEE, Daejeon (KR); Intark HAN, Daejeon (KR)

(73) Assignee: ELECTRONICS AND TELECOMMUNICATIONS RESEARCH INSTITUTE, Daejeon (KR)

(21) Appl. No.: 19/030,834

(22) Filed: Jan. 17, 2025

(30) Foreign Application Priority Data
Jan. 31, 2024 (KR) 10-2024-0014704

(51) Int. Cl. G06T 17/00; G06F 3/01; G06T 7/20; G06T 7/70

(52) U.S. Cl. CPC G06T 17/00; G06F 3/012; G06T 7/20; G06T 7/70

(57) ABSTRACT

Disclosed are a training system and method for synchronizing a virtual reality site state and a real-world site state and performing tracking optimization based on dynamic object importance. The training system for synchronizing a virtual reality (VR) site state and a real-world site state and performing tracking optimization based on dynamic object importance includes a sensor data processor configured to estimate the pose and state of a real object from sensor data and to update the state of an object within a VR site based on the pose and state of the real object.

This application claims priority from and the benefit of Korean Patent Application No. 10-2024-0014704, filed on Jan. 31, 2024, which is hereby incorporated by reference for all purposes as if set forth herein.

### BACKGROUND

### 1. Technical Field

The present disclosure relates to a training system and method for synchronizing a virtual reality site state and a real-world site state and performing tracking optimization based on dynamic object importance.

### 2. Related Art

In the development of a virtual reality (VR) training system in order to improve the results of training, the demand for realism has been increasing. A tactile interaction with a real object may be provided while monitoring a three-dimensional (3-D) model of VR through a VR training system in which a VR training site and a real-world training site have been synchronized. An object of using a 3-D model of a real object in VR is to allow a greater change of appearance for satisfying training scenario requirements. An objective of using a real object is to increase the reality of an interaction and improve the results of the training by providing a tactile interaction.

In order to achieve the objectives, avatar of VR and a 3-D model need to be synchronized with a real trainee and a real object. Accordingly, when the trainee reaches the object while being guided by a VR view, the trainee may touch the real object as expected. Furthermore, when the trainee moves the real object, the trainee can see that the 3-D model moves in the VR.

To this end, the postures (or poses) of the real object and the trainee that require a tactile interaction need to be tracked according to a scenario. For an actual implementation, there is a trade-off relation in requirements for high tracking accuracy and a low cost (or expenses). A high precision tracking system, such as OptiTrack, has low latency, but requires a high cost and additional infrastructure (e.g., a camera) and requires a marker to be attached to the trainee.

Recently, with the advancement of methods using RGB cameras combined with depth cameras or LiDAR, it has become a viable and cost-effective alternative. In order to apply such a tracking method, an additional trade-off relation related to computing resources needs to be considered. Server-based computation may achieve low latency upon tracking, but requires high requirements for network communication. In contrast, when an embedded/wearable computer or a backpack computer is used, the number of objects that may be tracked and a tracking speed are limited.

### SUMMARY

Various embodiments are directed to increasing the number of tracking objects and reducing tracking latency for an important object by synchronizing a VR site state and a real-world site state and performing tracking optimization based on dynamic object importance. The importance of a tracked object is dynamically assigned in order to support a smooth interaction between a virtual/real object and a trainee within a training system.

A training system for synchronizing a virtual reality (VR) site state and a real-world site state and performing tracking optimization based on dynamic object importance according to an embodiment of the present disclosure includes a sensor data processor configured to estimate the pose and state of a real object from sensor data and to update the state of an object within a VR site based on the pose and state of the real object.

The sensor data are obtained by a sensor comprising at least any one of IMU, an RGBD camera, and LiDAR.

The sensor data processor receives context extracted from the sensor data and a dynamic scene graph.

The dynamic scene graph is initially generated from a description of a training site and is updated by a detection of a change in the state, which occurs due to an interaction between a VR training site and a trainee and an interaction between a real-world training site and the trainee upon runtime.

The sensor data processor includes a helmet pose tracking module configured to estimate a pose of a helmet in order to estimate a posture of a sensor attached to a helmet that is worn by a trainee, a trainee ego-pose tracking module configured to estimate a pose of the trainee on the basis of a camera attached to the helmet, an object pose tracking module configured to estimate the pose and state of the real object, and a scene graph update module configured to perform scene graph updates by using the pose of the trainee, the pose of the helmet, and the pose and state of the real object.

The object pose tracking module includes an object importance ranking selection neural network configured to estimate an importance value of an object within the VR site, a target object selector configured to prepare a list of target objects based on the real object detected in a current view, and an object pose neural network configured to estimate the pose and state of the target object selected based on the sensor data.

The object importance ranking selection neural network estimates the importance value of each object within the VR site, which is indicated based on the pose of the trainee, the pose of the helmet, context extracted from the dynamic scene graph, and sensor data.

The object importance ranking selection neural network assigns a relatively higher importance value to at least any one of an object on which the trainee's eyes are focused, an object with which the trainee currently interacts, and an object to which the trainee's focus is expected to be changed in a near future or with which the trainee is expected to start an interaction.

The target object selector tracks the real object having relatively higher importance at a relatively higher speed and tracks the real object having relatively lower importance at a relatively lower speed.

A training method of synchronizing a virtual reality (VR) site state and a real-world site state and performing tracking optimization based on dynamic object importance according to an embodiment of the present disclosure including steps of (a) receiving context extracted from a dynamic scene graph and sensor data, and (b) estimating the pose and state of a real object based on the context and the sensor data and updating a state of an object within a VR site.

The dynamic scene graph is initially generated according to a training site scenario and updated by an interaction between the VR site and a trainee and an interaction between a real-world site and the trainee upon runtime.

The sensor data include data obtained by at least any one of IMU, an RGBD camera, and LiDAR.

The step (b) includes estimating a pose of a helmet worn by a trainee, a pose of the trainee, and the pose and state of the real object and performing updates on the dynamic scene graph.

The step (b) includes estimating an importance value of an object within the VR site, preparing a list of target objects from the real object detected in a current view, and estimating the pose and state of the target object detected based on the sensor data, in estimating the pose and state of the real object.

The step (b) includes estimating the importance value of each object within the VR site, which is indicated based on the pose of the trainee, the pose of the helmet, context extracted from the dynamic scene graph, and sensor data.

The step (b) includes assigning a relatively higher importance value to at least any one of an object on which the trainee's eyes are focused, an object with which the trainee currently interacts, an object to which the trainee's focus is expected to be changed in the near future or with which the trainee is expected to start an interaction.

The step (b) includes tracking the real object having relatively higher importance at a relatively higher speed and tracking the real object having relatively lower importance at a relatively lower speed.

According to the embodiments of the present disclosure, it is possible to assign dynamic importance to candidate objects for the tracking of a posture in a mixed reality training system.

According to the embodiments of the present disclosure, a smooth interaction is supported between a trainee and a real object within a mixed reality system by selecting a tracking target object the tracking speed of which is controlled.

According to the embodiments of the present disclosure, it is possible to define context data and to obtain context data from a training system.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a concept view illustrating a training system and requirements for state updates according to embodiments of the present disclosure.

FIG. 2 illustrates the training system and a loop of state update sensing-processing-update according to embodiments of the present disclosure.

FIG. 3 illustrates the training system and state update processing according to embodiments of the present disclosure.

FIG. 4 illustrates an object pose tracking module according to an embodiment of the present disclosure.

FIG. 5 illustrates the training system and a flowchart of state updates according to embodiments of the present disclosure.

FIG. 6 illustrates a flowchart of the tracking of the pose of an object according to an embodiment of the present disclosure.

FIG. 7 is a block diagram illustrating a computer system for implementing a method according to an embodiment of the present disclosure.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

According to an embodiment of the present disclosure, in a mixed reality training system, in order to support a smooth interaction between an object and a trainee, a virtual reality (VR) site state and a real-world site state are synchronized. A training system according to an embodiment of the present disclosure includes a real-world training site including a real object (RO) that is necessary to provide a tactile interaction according to a training scenario. Furthermore, the training system according to an embodiment of the present disclosure includes a VR training site (or VR simulator) including virtual objects with real counterparts in the real-world training site (VORC) and virtual objects with no counterparts in the real world training site (VONC).

The VORC according to an embodiment of the present disclosure has essential geometric properties of a corresponding RO that are necessary to support a tactile interaction required by a training scenario. The VORC has a visual shape required by the training scenario, which may be different from a visual shape of a real object. In the initial state of a training system, the pose and state of the VORC are matched with the pose and state of an RO.

The training system according to an embodiment of the present disclosure includes at least one trainee in the real world, which corresponds to avatar (i.e., virtual expression) in a VR training site. The trainee monitors the VR training site through a head mount display (HMD).

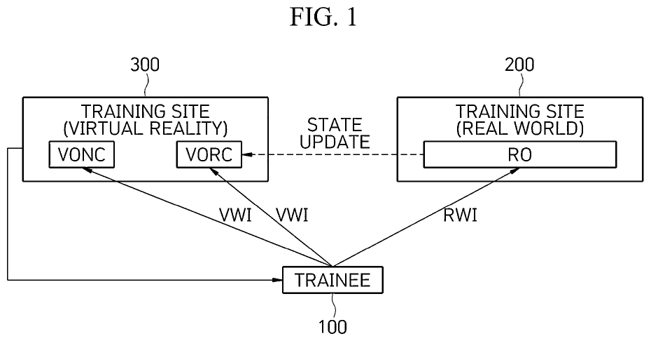

FIG. 1 is a concept view illustrating a training system and requirements for state updates according to embodiments of the present disclosure.

As illustrated in FIG. 1, according to an embodiment of the present disclosure, two types of interactions between a trainee 100 and an object of a scenario are considered, and include a real-world interaction (RWI) and a virtual world interaction (VWI). The RWI is an interaction (e.g., door opening) between the trainee 100 and an RO within a real-world training site 200. The VWI is an interaction (e.g., shooting for a virtual object) between the trainee 100 and VORC and VONC within a VR training site 300. The RWI may change the location, direction, or state of the RO (e.g., a door state is changed from a closed state to an open state). In this case, the locations, directions, or states of the VORCs need to be synchronized so that the recognition of the trainee for the VORCs through a head mount display is matched with recognition for the RO. This is indicated as a state update (SU) in FIG. 1, and is indicated as a red arrow from the RO to the VORC.

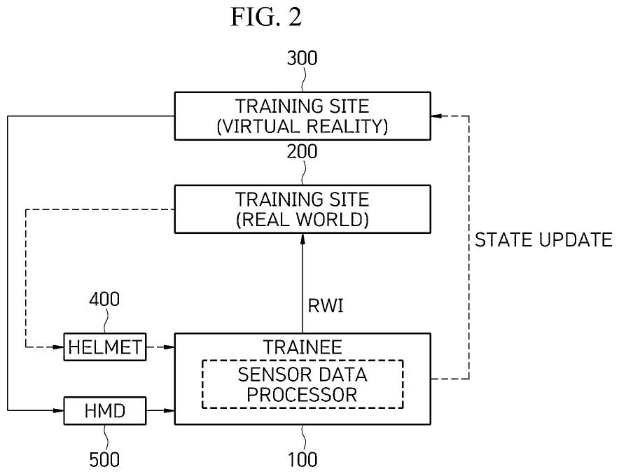

FIG. 2 illustrates the training system and a loop of state update sensing-processing-update according to embodiments of the present disclosure.

As illustrated in FIG. 2, a state update (SU) is expanded as additional detailed information that is indicated in red. After an RWI between the RO within the real-world training site 200 and the trainee 100, there is a difference between the pose and state of the RO and the pose and state of a corresponding VORC. In order to perform the required state update, a helmet 400 in which a set of sensors (e.g., IMU, an RGBD cameras, or LiDAR) are disposed and a wearable computer are mounted on the trainee 100.

A sensor data processor (SDP) is performed in the wearable computer, and is performed in order to estimate the pose and state of a new RO from detected sensor data. Furthermore, the estimated pose and state of the new RO is used to perform updates on the state of the corresponding VORC in the VR training site 300.

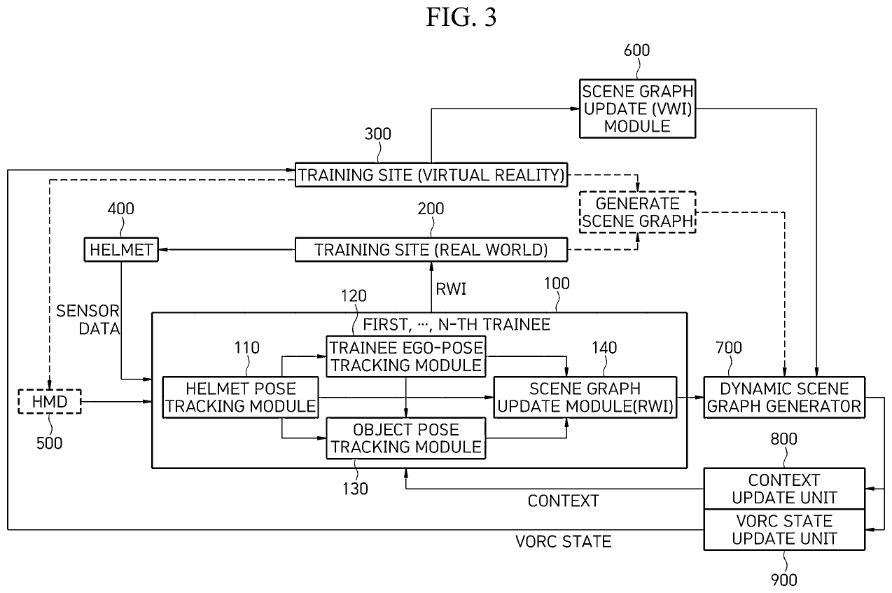

FIG. 3 illustrates the training system and state update processing according to embodiments of the present disclosure.

The RWI between the trainee 100 and the RO within the real-world training site 200 causes a change in the pose and state of a sensor attached to the helmet 400 and the pose and state of the RO, which are monitored based on sensor data. An input for the processing of the sensor data includes the sensor data and context.

The context is extracted from a dynamic scene graph. The dynamic scene graph includes a related description of a VR training site, and includes a VORC, a VONC, trainee avatar, computer-generated forces (CGF) (also called non-playing characters (NPC)) and attributes (e.g., a pose and a state) thereof, and a relation (e.g., Door 1 is connected to Room 1 and Room 2), for example. The dynamic scene graph is initially generated from the description of the training site, and is updated by the detection of a change in the state, which occurs due to an RWI and a VWI upon runtime. After the VWI, a new pose and state of an interaction target VONC or VORC are calculated by the VR simulator. The updates of the dynamic scene graph are performed based on the update of the dynamic scene graph attributable to the VWI.

The sensor data processor of the trainee 100 includes the following processing modules.

A helmet pose tracking module 110 tracks the pose of the helmet 400 on the basis of the origin point of a training site coordinate system in order to estimate the posture (i.e., location and direction) of the sensor attached to the helmet 400.

A trainee ego-pose tracking module 120 estimates the posture of the trainee (e.g., the location and direction of a skeleton joint) on the basis of the camera of the helmet.

An object pose tracking module 130 estimates the pose and state of an RO (e.g., the location and direction of a chair, the location and direction of a box, or an opening angle of a lid) which is seen to a human eye.

A scene graph update module 140 performs scene graph updates according to an RWI in order to update a dynamic scene graph by using the pose and state of a newly estimated RO along with the pose of the trainee and the pose of the helmet.

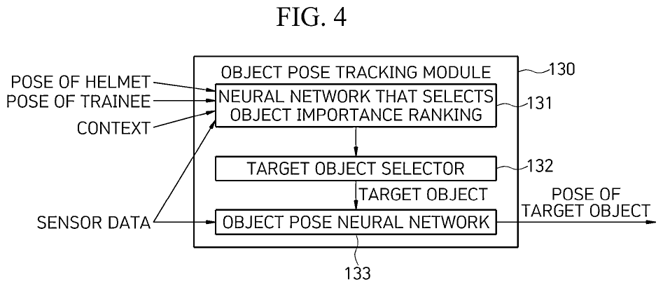

FIG. 4 illustrates the object pose tracking module 130 according to an embodiment of the present disclosure.

It is necessary to optimize the tracking speed of an RO in order to provide a smooth interaction between a trainee and the RO within a training system by considering limited computation resources, required low latency, and a large number of ROs in a camera view.

A neural network 131 that selects object importance ranking detects a VORC (e.g., semantic segmentation in a current RGBD image) that is currently displayed in a current view of sensor data, and estimates an importance value of each VORC, which is indicated based on the pose of the helmet, the pose of the trainee, context extracted from the dynamic scene graph, and sensor data.

A training target of the neural network 131 that selects object importance ranking is to assign a relatively higher importance value to an object on which the trainee's eyes are focused, an object with which the trainee currently interacts, and an object to which the trainee's focus is expected to be changed in the near future or with which the trainee is expected to start an interaction. In order to reduce the possibility that the pose and state of the object will be suddenly changed when the focus of the trainee is changed, importance is assigned to the object by considering an interaction which may occur in the near future.

Architecture of the neural network 131 that selects object importance ranking is based on time-series neural network model architecture, such as LSTM, a transformer, and a state space model (e.g., S4ND). Alternatively, if input data are expressed in a graph form, architecture of the neural network 131 that selects object importance ranking is based on a geometric neural network (e.g., a graph convolution neural network).

A target object selector 132 prepares a list of target objects from an RO detected in a current view based on a probability, that is, an estimation function of an importance value of the RO. Accordingly, in order to provide a smooth interaction, an RO having high importance is tracked at a relatively higher speed, and an RO having less importance is tracked at a relatively lower speed, thereby reducing a computational load.

An object pose neural network 133 repeats the estimation of the pose and state of a target object that is selected based on sensor data. A list of RO poses including the ID of a corresponding RO is estimated and output.

An input for the tracking of the pose of an object is as follows. Sensor data are the data of the sensor attached to the helmet of the trainee. The sensor includes IMU, an RGBD camera, an IR camera, and LiDAR. An expression based on a tensor (multi-dimensional array) is performed. The pose of the helmet is estimated with respect to the pose of the helmet of the trainee, and is expressed as a location vector and a rotation matrix on the basis of the origin point of a coordinate system of a training site. The pose of the trainee is a currently estimated pose of the trainee and is expressed as the tensor of the location and direction of a skeleton joint. Context is a subset of dynamic scene graphs including entities (i.e., VORCs and VINCs) related to an RWI of the trainee, which is possible currently and in the near future. The context includes the task of the trainee according to a training scenario. VONCs and VORCs that are estimated to be included in the field of view of the trainee are input. VONCs and VORCs which are within a preset range on the basis of the location of the trainee and listed as interaction targets of the trainee in a current time window according to a scenario are input.

The neural network 131 that selects object importance ranking adds the following elements through the additional pre-processing of context data. The proximity of an object to a current focus is added. A current focus point is estimated the tracking of the field of view, and is indicated as a two-dimensional (2-D) point in a current image that is displayed in a head mount display (HMD). The proximity of the object to the current focus is estimated by a preset function. The 2-D speed of the object based on an Euclid distance from the current focus point to the geometric center of a current 2-D boundary box of the object, the size of the object, and the current focus is considered, and is expressed as additional object attributes having a tensor form. The proximity of the object is added to a current location of the trainee. The location of the trainee is estimated based on the pose of the helmet and the pose of the camera, which are expressed as 3-D points of a world coordinate system. The proximity of the object to the current location of the trainee based on the Euclid distance from the location of the trainee to the geometric center of the current 3-D boundary box of the object, the size of the object, and the 3-D speed of the object for the current location of the trainee is considered, and is expressed as additional object attributes having a tensor form. The type of current interaction with the object is added. For example, an interaction type including tactile interactions, such as a direct hand interaction, an indirect tool-based interaction, and stepping or sitting, is added. For example, an interaction type for a case in which the trainee passes between a wall and a chair is added, and is expressed as additional trainee-object relation attributes having a tensor form.

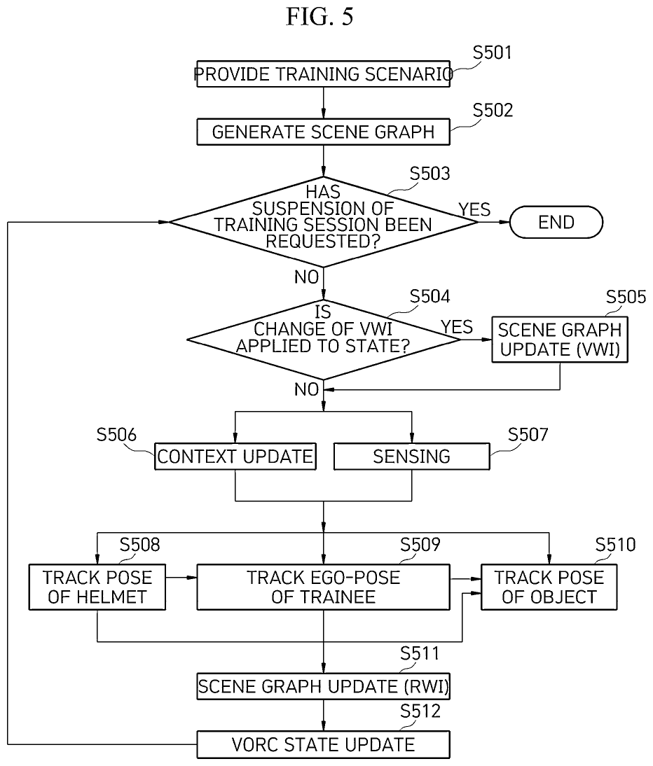

FIG. 5 illustrates the training system and a flowchart of state updates according to embodiments of the present disclosure.

In step S501, a training scenario of which trainee will participate, which tasks should be performed, and in which environment the training scenario should be performed is provided. An environment description includes VORCs, VONCs (including a CGF), an initial pose, and a regulated operation. According to an embodiment of the present disclosure, a real-world training site and a VR training site are prepared based on the environment description.

In step S502, a scene graph is generated. An initial configuration of a dynamic scene graph is prepared in the description of the training scenario.

In step S503, when the suspension of a training session is requested, processing is terminated.

When the suspension of the training session is not requested in step S503, in step S504, whether a change of a VWI has been applied to the state of the VR simulator is checked.

If the change has been applied to the state of the VR simulator, in step S505, scene graph updates are performed so that the change is incorporated.

Context updates are performed on a dynamic scene graph in parallel (S506), and sensing using the sensor of the helmet is performed (S507).

The tracking of the posture of the helmet, the tracking of the ego-pose of the trainee, and the tracking of the pose of an object are simultaneously performed according to data sharing requirements (S508, S509, and S510). For example, the estimated pose of the helmet is used for the tracking of the ego-pose of the trainee and the tracking of the pose of the object.

In step S511, scene graph updates attributable to an RWI are performed based on the results of the processing of the tracking of the poses.

In step S512, changes (e.g., the pose of the trainee and the pose of an RO) related to the scene graph are transmitted to the VR simulator so that the state of the VORCs are updated. The process returns to step S503 of checking when the suspension of a training session is requested.

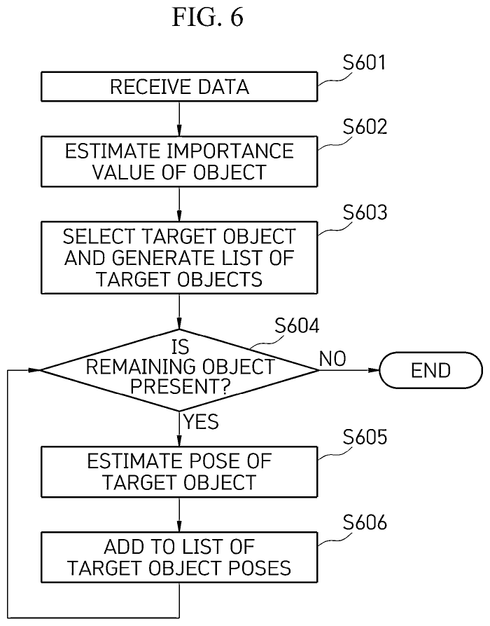

FIG. 6 illustrates a flowchart of the tracking of the pose of an object according to an embodiment of the present disclosure.

In step S601, sensor data, the pose of the helmet, the pose of the trainee, and context data are received.

In step S602, the neural network that selects object importance ranking performs context data pre-processing and estimates an importance value of a corresponding object.

In step S603, a target object is selected based on the importance value of the corresponding object, and a list of target objects is generated.

In step S604, whether a remaining object is present is checked.

In step S605, the object pose neural network estimates the pose of the target object from the list of target objects. The poses of the target objects are sequentially estimated. If computing resources are sufficient, the poses of the target objects are estimated one by one or in a lump (a plural number in one step).

In step S606, the estimated pose of the target object is added to a list of target object poses.

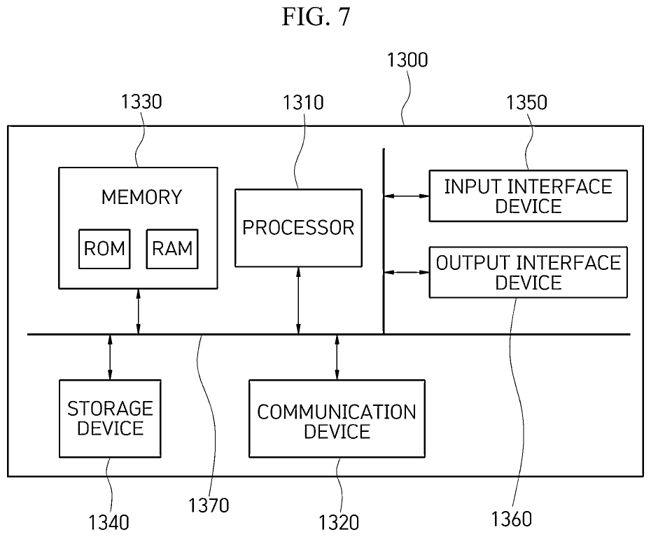

FIG. 7 is a block diagram illustrating a computer system 1300 for implementing a method according to an embodiment of the present disclosure.

Referring to FIG. 7, a computer system 1300 may include at least one of a processor 1310, memory 1330, an input interface device 1350, an output interface device 1360, and a storage device 1340 which communicate with each other through a bus 1370. Furthermore, the computer system 1300 may include a communication device 1320 connected to a network. The processor 1310 may be a central processing unit (CPU) or may be a semiconductor device that executes instructions stored in the memory 1330 or the storage device 1340. The memory 1330 and the storage device 1340 may each include various types of volatile or nonvolatile storage media. For example, the memory may include read only memory (ROM) and random access memory (RAM). In an embodiment of the present specification, the memory may be disposed inside or outside the processor and connected to the processor through various known means. The memory includes various types of volatile or nonvolatile storage media, and may include ROM or RAM, for example.

Accordingly, an embodiment of the present disclosure may be implemented as a method implemented in a computer or may be implemented as a non-transitory computer-readable medium in which a computer-executable instruction has been stored. In an embodiment, when being executed by a processor, a computer-readable instruction may perform a method according to at least one aspect of this writing.

The communication device 1320 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

What is claimed is:

1. A training system for synchronizing a virtual reality (VR) site state and a real-world site state and performing tracking optimization based on dynamic object importance, the training system comprising:
a sensor data processor configured to estimate a pose and state of a real object from sensor data and to update a state of an object within a VR site based on the pose and state of the real object.

2. The training system of claim 1, wherein the sensor data are obtained by a sensor comprising at least any one of IMU, an RGBD camera, and LiDAR.

3. The training system of claim 1, wherein the sensor data processor receives context extracted from the sensor data and a dynamic scene graph.

4. The training system of claim 3, wherein the dynamic scene graph is initially generated from a description of a training site and is updated by a detection of a change in a state, which occurs due to an interaction between a VR training site and a trainee and an interaction between a real-world training site and the trainee upon runtime.

5. The training system of claim 1, wherein the sensor data processor comprises:
a helmet pose tracking module configured to estimate a pose of a helmet in order to estimate a posture of a sensor attached to a helmet that is worn by a trainee;
a trainee ego-pose tracking module configured to estimate a pose of the trainee on the basis of a camera attached to the helmet;
an object pose tracking module configured to estimate the pose and state of the real object; and
a scene graph update module configured to perform scene graph updates by using the pose of the trainee, the pose of the helmet, and the pose and state of the real object.

6. The training system of claim 5, wherein the object pose tracking module comprises:
an object importance ranking selection neural network configured to estimate an importance value of an object within the VR site;
a target object selector configured to prepare a list of target objects based on the real object detected in a current view; and
an object pose neural network configured to estimate a pose and state of the target object selected based on the sensor data.

7. The training system of claim 6, wherein the object importance ranking selection neural network estimates the importance value of each object within the VR site, which is indicated based on the pose of the trainee, the pose of the helmet, context extracted from the dynamic scene graph, and sensor data.

8. The training system of claim 6, wherein the object importance ranking selection neural network assigns a relatively higher importance value to at least any one of an object on which the trainee's eyes are focused, an object with which the trainee currently interacts, and an object to which the trainee's focus is expected to be changed in a near future or with which the trainee is expected to start an interaction.

9. The training system of claim 6, wherein the target object selector tracks the real object having relatively higher importance at a relatively higher speed and tracks the real object having relatively lower importance at a relatively lower speed.

10. A training method of synchronizing a virtual reality (VR) site state and a real-world site state and performing tracking optimization based on dynamic object importance, the training method being performed by a training system for synchronizing a VR site state and a real-world site state and performing tracking optimization based on dynamic object importance and comprising steps of:
(a) receiving context extracted from a dynamic scene graph and sensor data; and
(b) estimating a pose and state of a real object based on the context and the sensor data and updating a state of an object within a VR site.

11. The training method of claim 10, wherein the dynamic scene graph is initially generated according to a training site scenario and updated by an interaction between the VR site and a trainee and an interaction between a real-world site and the trainee upon runtime.

12. The training method of claim 10, wherein the sensor data comprise data obtained by at least any one of IMU, an RGBD camera, and LiDAR.

13. The training method of claim 10, wherein the step (b) comprises estimating a pose of a helmet worn by a trainee, a pose of the trainee, and the pose and state of the real object and performing updates on the dynamic scene graph.

14. The training method of claim 13, wherein the step (b) comprises estimating an importance value of an object within the VR site, preparing a list of target objects from the real object detected in a current view, and estimating the pose and state of the target object detected based on the sensor data, in estimating the pose and state of the real object.

15. The training method of claim 14, wherein the step (b) comprises estimating the importance value of each object within the VR site, which is indicated based on the pose of the trainee, the pose of the helmet, context extracted from the dynamic scene graph, and sensor data.

16. The training method of claim 14, wherein the step (b) comprises assigning a relatively higher importance value to at least any one of an object on which the trainee's eyes are focused, an object with which the trainee currently interacts, an object to which the trainee's focus is expected to be changed in the near future or with which the trainee is expected to start an interaction.

17. The training method of claim 14, wherein the step (b) comprises tracking the real object having relatively higher importance at a relatively higher speed and tracking the real object having relatively lower importance at a relatively lower speed.
